(19) United States
(12) Patent Application Publication
(10) Pub. No.: US 2015/0314908 A1
(43) Pub. Date: Nov. 5, 2015

(54) WELDED CAN BODY, WELDED CAN, METHOD OF MANUFACTURING WELDED CAN BODY, AND METHOD OF MANUFACTURING WELDED CAN

(71) Applicant: JFE Steel Corporation, Tokyo (JP)

(72) Inventors: Yujiro Morioka, Kounosu-shi (JP); Takashi Arai, Kounosu-shi (JP); Nobuyuki Kobayashi, Kounosu-shi (JP); Hiroshi Kubo, Tokyo (JP)

(21) Appl. No.: 14/761,971

(22) PCT Filed: Jan. 24, 2014
(86) PCT No.: PCT/JP2014/051584

§ 371 Date: Jul. 20, 2015

(30) Foreign Application Priority Data
Jan. 29, 2013 (JP) 2013-014644

(51) Int. Cl. B65D 1/12; B23K 26/40; B23K 11/34; B23K 11/06; B23K 11/00; B21D 51/26; B23K 26/36

(52) U.S. Cl. CPC B65D 1/12; B21D 51/26; B23K 26/4095; B23K 26/365; B23K 11/066; B23K 11/0026; B23K 11/34

(57) ABSTRACT

This welded can body is constituted of a steel plate material formed from a tin-free steel plate or a resin coated steel plate wherein a tin-free steel plate is coated with a resin, overlapping corresponding parts with each other, and forming a weld part by resistance welding of the overlapped parts. Laser processing parts formed on at least one of four surfaces made up of two surfaces constituting electrode contact surfaces on sides that contact an electrode (A) during resistance welding and two surfaces constituting joining surfaces on sides where the steel plate material is joined together, have laser irradiation parts, wherein laser irradiation is carried out before resistance welding to eliminate chrome plating and expose the steel plate, separately disposed on parts to be welded to become the weld parts, on the steel plate material.

### TECHNICAL FIELD

This disclosure relates to a weld can body, a weld can, a weld can body manufacturing method, and a weld can manufacturing method that enable improvement in production efficiency in manufacturing cans when weld cans such as 18 liter cans and general cans are formed by joining welding portions of a material steel sheet constituted of a chromium-plated steel sheet or a resin-coated steel sheet having a chromium-plated steel sheet covered with a resin film, for instance, a laminating film by resistance welding.

This application claims priority to Japanese Patent Application No. 2013-014644 filed on Jan. 29, 2013 in Japan, the disclosure of that application being incorporated herein by reference in its entirety for all purposes.

### BACKGROUND

As is well known, metal cans such as 18 liter cans and general cans are manufactured such that welding-expected portions of a material steel sheet overlap and welded by a resistance welding method, for instance, a seam welding method to thereby form a body of weld can and a top plate (bottom plate) is attached to the body of the weld can.

Material steel sheets used to form such a weld can include a tin plate, a chromium-plated steel sheet (hereinafter called a tin free steel sheet) and a resin-coated steel sheet constituted of a tin free steel sheet covered with a resin film.

Generally, in a tin free steel sheet, hydrated chromium oxide is formed on the surface of chromium metal and, accordingly, the electrical resistance is high. Therefore, it is difficult to join edges of the tin free steel sheet having undergone no processing, by resistance welding performed by bringing the steel sheet in contact with electrodes to pass current.

To lower the electrical resistance to facilitate welding, removal of a chromium plating film at welding portions through physical polishing, modification of a chromium plating film of a tin free steel sheet, or the like is carried out as a pretreatment of welding.

However, when the welding portions are physically polished, polishing debris and the like may adhere to the resultant can and stay therein and, therefore, the need to prevent remaining polishing debris and the like from being mixed into a product in the can arises. When contents filling the can is food or the like, particular attention is required.

In addition, when the welding portions are physically polished, the chromium plating film is completely removed and, consequently, when a resin film is formed on the welding portions by repair painting, repair laminating or the like, adhesion to the resin film such as a repair paint film or a repair laminating film is at a low level.

As a result, contents easily penetrate the welded portion and worse still, since no chromium plating film is present on the welded portion, the welded portion has a low corrosion resistance when the contents penetrate, resulting in corrosion.

To overcome the foregoing problems, there is disclosed, for instance, a technique of forming a chromium plating film on a tin free steel sheet so that the resultant steel sheet has a low electrical resistance (see, for example, JP 6-37712 B).

According to the technique described in JP '712, since the electrical resistance of the tin free steel sheet is low, good weldability is ensured and, consequently, the technique is widely used.

In addition, to overcome the foregoing problems, there is disclosed, for instance, a polishing method using laser to completely remove a chromium plating film on a welding-expected portion of a tin free steel sheet by irradiation with laser light, which is carried out as a pretreatment of welding (see, for example, JP 62-34682 A).

According to the polishing method using laser described in JP '682, while complete removal of a chromium plating film of a plating layer has been difficult for conventional physical polishing methods, such a plating layer can be completely removed by irradiation with laser, thus resulting in good weldability. Furthermore, since dust or debris is hardly generated at removal of the chromium plating film, it is possible to minimize dust, debris and the like that may be mixed into a product in the resultant can.

However, in the technique disclosed in JP '712, while the amount of hydrated chromium oxide is small and the electrical resistance is lowered whereby the weldability is improved, corrosion resistance is lowered compared to a common tin free steel sheet. Hence, it is difficult to obtain stable effects of a weld can in uses requiring sufficient corrosion resistance.

In the technique disclosed by JP '682, since the chromium plating is completely removed in a pretreatment process of welding, it is effective in that the welding portions can be effectively and stably joined by resistance welding.

However, the entire area of the welding portions needs to be irradiated with laser at high power to completely remove the plating film on the welding portions and, therefore, the machining time per can is elongated. In addition, when a laser polishing process is incorporated in the can manufacturing line, this leads to the decrease in line speed and impairs the productivity.

These are great disadvantages for practical application of the laser polishing technique so that the technique is not widely used.

Furthermore, polishing using a laser is not widely used also because the corrosion resistance at a welded portion is not maintained (due to poor adhesion to repair paint or a repair film as a result of complete removal of plating).

It could, therefore, be helpful to provide a weld can body, a weld can, a weld can body manufacturing method, and a weld can manufacturing method that enable at the time of manufacturing a weld can such as an 18 liter can or a general can by joining edges of a material steel sheet constituted of a tin free steel sheet or a resin-coated steel sheet covered with a resin film, for instance, a laminating film by resistance welding, at least one of the following purposes: (1) improving the weldability of welding-expected portions of a tin free steel sheet constituting a material steel sheet in resistance welding; (2) improving the machining speed of laser machining performed as a pretreatment of welding on welding-expected portions of a tin free steel sheet constituting a material steel sheet; (3) suppressing the amount of adhering or remaining dust, debris and the like generated in a pretreatment of welding performed on welding-expected portions of a tin free steel sheet constituting a material steel sheet; and (4) improving adhesion at a welded portion when a weld can is manufactured from a tin free steel sheet constituting a material steel sheet.

### SUMMARY

We thus provide:

In a first aspect, a weld can body obtainable by shaping a material steel sheet is constituted of a tin free steel sheet or a resin-coated steel sheet having a tin free steel sheet covered with a resin film, overlapping corresponding portions with each other, and performing resistance welding on the corresponding portions overlapped to thereby form a welded portion, wherein on welding-expected portions that are to be the welded portion in the material steel sheet, at least one of four regions consisting of two regions constituting electrode contact regions to be brought in contact with electrodes at the resistance welding and two regions constituting joint regions at which the corresponding portions of the material steel sheet are joined by the resistance welding is irradiated with laser before the resistance welding to form a laser-machined portion where laser-irradiated portions at which chromium plating is removed and a steel sheet is exposed are dividedly arranged.

In a second aspect, a weld can body manufacturing method of manufacturing a weld can body, comprises the steps of: shaping a material steel sheet constituted by a chromium-plated steel sheet or a resin-coated steel sheet having a chromium-plated steel sheet covered with a resin film; on the material steel sheet shaped, forming a laser-machined portion where laser-irradiated portions at which chromium plating is removed and a steel sheet is exposed are dividedly arranged at at least one of four regions consisting of two regions constituting electrode contact regions to be brought in contact with electrodes at resistance welding and two regions constituting joint regions at which corresponding portions of the material steel sheet are joined by the resistance welding, by irradiating with laser welding-expected portions that are to be a welded portion of the weld can body; overlapping the welding-expected portions of the material steel sheet shaped with each other; and joining by the resistance welding the welding-expected portions overlapped to thereby form the welded portion.

In a third aspect, a weld can is produced by attaching either or both of a top plate and a bottom plate to openings of the weld can body of the first aspect.

In a fourth aspect, a weld can manufacturing method produces a weld can by attaching either or both of a top plate and a bottom plate to openings of the weld can body manufactured by the weld can body manufacturing method of the second aspect.

According to the weld can body, the weld can, the weld can body manufacturing method, and the weld can manufacturing method, on welding-expected portions of a material steel sheet constituted of a tin free steel sheet or a resin-coated steel sheet covered with a resin film, at least one of four regions consisting of two regions constituting electrode contact regions to be brought in contact with electrodes at the resistance welding and two regions constituting joint regions at which the corresponding portions of the material steel sheet are joined by the resistance welding is subjected to laser irradiation to form a laser-machined portion where laser-irradiated portions at which chromium plating is removed and a steel sheet is exposed are dividedly arranged. As a result, it is possible to improve weldability when the welding-expected portions are resistance-welded.

In addition, the laser-irradiated portions are dividedly arranged in the welding-expected portions and, consequently, the laser-machined portions can be formed at a high speed.

The term “resin-coated steel sheet” refers to a steel sheet constituted of a tin free steel sheet having a resin film or films formed on its either or both surfaces. Examples of the resin film include a resin film formed on a surface of a tin free steel sheet by any of film forming methods such as painting (coating, spraying, and the like), printing, and evaporation; and a resin film such as a laminating film formed separately from a tin free steel sheet and integrally attached to a surface of the tin free steel sheet.

Exemplary resins include polypropylene resin (PP), polyethylene resin (PE), polyester resins such as polyethylene terephthalate (PET), epoxy resin, and other materials from which a resin film is formable.

The term “laser-irradiated portion” refers to a portion where a chromium plating covering a tin free steel sheet (including a resin-coated steel sheet) constituting a material steel sheet has been removed by irradiation with laser. The term “laser-machined portion” refers to a welding-expected portion where the laser-irradiated portions and non-irradiated portions are mixed.

The expression “laser-irradiated portions are dividedly arranged” refers to the state where the laser-irradiated portions are dividedly arranged on a straight line extending in at least any of directions on a surface of a material steel sheet. For instance, gaps may be formed between straight lines, which are a collection of straight lines (including a collection of straight lines arranged in parallel and a collection of straight lines crossing each other (in this case, an area surrounded by crossing straight lines may be isolated)), and laser-irradiated portions need not be arranged as a collection of dots that are divided in all directions.

In the first or second aspect, the amount of deposited chromium at the laser-irradiated portions is preferably up to 5 mg/m² in terms of chromium metal.

According to the weld can body and the weld can body manufacturing method, since a chromium plating is removed by laser irradiation and the amount of deposited chromium at the laser-irradiated portions is up to 5 mg/m² in terms of chromium metal, the electric resistance at a contact portion can be reduced and the welding stability can be improved.

In the first or second aspect, an area of the laser-irradiated portions in the laser-machined portion is preferably 10% or more but not more than 90% of the laser-machined portion.

According to the weld can body and the weld can body manufacturing method, an area of the laser-irradiated portions in the laser-machined portion is 10% or more but not more than 90% of the laser-machined portion and this improves, as well as the weldability, the adhesion to a resin film such as a repair paint film or a repair laminating film when a resin film is formed on the welded portion by repair painting, repair laminating or the like and accordingly, enhances the corrosion resistance.

In the first or second aspect, the laser-machined portions are preferably formed at, of the four regions constituting the welded portion, the two electrode contact regions.

According to the weld can body and the weld can body manufacturing method, the laser-machined portions are constituted of the two electrode contact regions and, therefore, the cost can be reduced compared to the case where laser-machined portions are formed at all regions (four regions) constituting the welded portion.

Furthermore, compared to when the laser-machined portions are formed at two joint regions at which the edges of the material steel sheet are joined, a weldable current range (hereinafter called “ACR”) being wide can be ensured in the resistant welding, thereby improving weldability.

According to the weld can body, the weld can, the weld can body manufacturing method, and the weld can manufacturing method, the laser-machined portion formed by irradiation with laser and where the laser-irradiated portions, at which the chromium plating is removed and the steel sheet is exposed, are dividedly arranged is formed at at least one of four regions constituting the welded portion in the material steel sheet, whereby the resistance is decreased as a whole and weldability at resistance welding can be improved.

In addition, the laser-irradiated portions are dividedly arranged in the welding-expected portions and, therefore, the laser machining which is a pretreatment of welding can be performed at a high speed.

### BRIEF DESCRIPTION OF THE DRAWINGS

FIG. 1 is a view showing an exemplary general configuration of a prismatic can according to a first example.

FIG. 2A is a perspective view showing an example of an outline of a manufacturing process of the prismatic can according to the first example, specifically showing the state where laser-machined portions are formed at a material steel sheet by irradiation with laser beams using laser irradiating devices.

FIG. 2B is a perspective view showing an example of the outline of the manufacturing process of the prismatic can according to the first example, specifically showing the state where welding-expected portions are joined by seam-welding an intermediate product of a can body.

FIG. 2C is a perspective view showing an example of the outline of the manufacturing process of the prismatic can according to the first example, specifically showing a manufactured can body.

FIG. 3 is a cross-sectional view showing an exemplary general configuration of a tin free steel sheet constituting the material steel sheet according to the first example.

FIG. 4 is a schematic view showing an example of a step of forming the laser-machined portions at the material steel sheet by irradiation with laser in a weld can manufacturing process according to the first example.

FIG. 5 is a cross-sectional view illustrating an exemplary general configuration of laser-irradiated portions formed at the tin free steel sheet according to the first example.

FIG. 6A is a schematic view showing an exemplary arrangement of the laser-machined portions at the material steel sheet to be used for the weld can body according to the first example.

FIG. 6B is a schematic view showing an exemplary general configuration of arrangement of the laser-irradiated portions in the laser-machined portion formed at the material steel sheet to be used for the weld can body according to the first example.

FIG. 7A is a view showing an example of resistance welding of the welding-expected portions in the weld can manufacturing process according to the first example, specifically showing an outline of the state where the welding-expected portions of the weld can body are seam-welded by electrode rollers.

FIG. 7B is a cross-sectional view showing an exemplary arrangement of the laser-machined portions at the welding-expected portions subjected to resistance welding in the weld can manufacturing process according to the first example.

FIG. 8A is a view illustrating a general configuration of a first modification in which the arrangement of the laser-irradiated portions is modified in the laser-machined portion at the material steel sheet to be used for the weld can body according to the first example.

FIG. 8B is a view illustrating a general configuration of a second modification in which the arrangement of the laser-irradiated portions is modified in the laser-machined portion at the material steel sheet to be used for the weld can body according to the first example.

FIG. 9A is a view illustrating an exemplary general configuration of laser-irradiated portions in a laser-machined portion at a material steel sheet to be used for a weld can body according to a second example.

FIG. 9B is a view illustrating a general configuration of a first modification in which the arrangement of the laser-irradiated portions is modified in the laser-machined portion at the material steel sheet to be used for the weld can body according to the second example.

FIG. 9C is a view illustrating a general configuration of a second modification in which the arrangement of the laser-irradiated portions is modified in the laser-machined portion at the material steel sheet to be used for the weld can body according to the second example.

FIG. 9D is a view illustrating a general configuration of a third modification in which the arrangement of the laser-irradiated portions is modified in the laser-machined portion of the material steel sheet to be used for the weld can body according to the second example.

FIG. 10 is a cross-sectional view illustrating an exemplary general configuration of arrangement of laser-machined portions at a material steel sheet when welding-expected portions are resistance-welded in a weld can body manufacturing process according to a third example.

FIG. 11 is a cross-sectional view showing an exemplary general configuration of a laminated steel sheet to be used for a weld can body according to a fourth example.

FIG. 12 is a view showing an exemplary general configuration of a cylindrical can according to a fifth example.

FIG. 13A is a perspective view showing an example of an outline of a manufacturing process of the cylindrical can according to the fifth example, specifically showing the state where laser-machined portions are formed at a material steel sheet by irradiation with laser beams using laser irradiating devices.

FIG. 13B is a perspective view showing an example of the outline of the manufacturing process of the cylindrical can according to the fifth example, specifically showing the state where welding-expected portions are joined by seam-welding an intermediate product of a can body.

FIG. 13C is a perspective view showing an example of the outline of the manufacturing process of the cylindrical can according to the fifth example, specifically showing a manufactured can body.

FIG. 14 is a view showing exemplary general configurations of the laser-machined portion(s) at the welded portion for explaining the examples.

### REFERENCE SIGNS LIST

W0 prismatic can (weld can)
W10 cylindrical can (weld can)
W1, W1A can body (weld can body)
W11, W11A top plate
W12, W12A bottom plate
M material steel sheet
MR laminated steel steel sheet (material steel sheet, resin-coated steel sheet)
M1 steel sheet
M2 chromium plating layer
M3 hydrated chromium oxide layer
F laminating film (resin film)
A, A1, A2 electrode roller (electrode)
G, G1, G2, G3, G4 laser-machined portion
11 welded portion
12 welding-expected portion
13 laser-irradiated portion

### DETAILED DESCRIPTION

We studied improvements in weldability in resistance welding of welding-expected portions of a material steel sheet constituted of a tin free steel sheet or a resin-coated steel sheet covered with a resin film, for instance, a laminating film. We found that when an insulating film formed of chromium plating is partially left on purpose, this enables high-speed removal of a chromium plating film by irradiation with laser and improves adhesion to a welding repair portion or a laminating repair portion as well as corrosion resistance at a welded portion. Examples are described in detail below.

### First Example

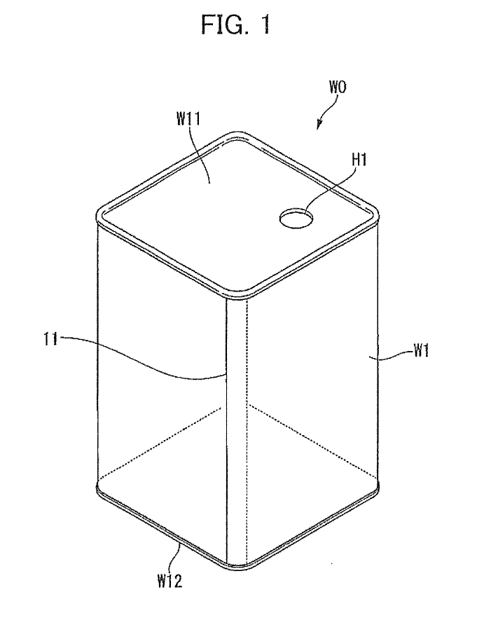

A first example is described below with reference to FIGS. 1 to 8B.

FIG. 1 is a view showing a general configuration of a can according to the first example. Reference symbol W0 denotes a prismatic can such as an 18 liter square can (Square Can) (weld can), reference symbol W1 denotes a weld can body, and reference symbol 11 denotes a welded portion of the weld can body.

The prismatic can W0 includes, for instance, the can body W1 formed in a tubular shape, a top plate W11, and a bottom plate W12, and the top plate W11 and the bottom plate W12 are separately attached to openings of the can body W1 at the opposite ends thereof, as shown in FIG. 1.

A hole H1 is formed at the top plate W11 to allow the contents to enter and fill the interior of the prismatic can W0 or to drain to the outside.

Joining of the can body W1 is carried out by, for instance, bending the material steel sheet having been shaped, overlapping edges of corresponding sides of the material steel sheet and resistance-welding the overlapped portions to thereby form the welded portion 11.

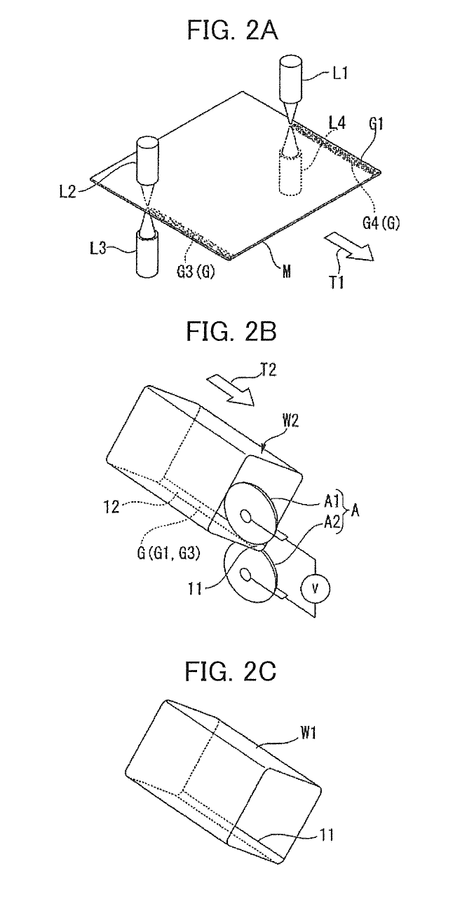

Next, the outline of a manufacturing method of a can W according to the first example is described with reference to FIGS. 2A to 2C. FIGS. 2A to 2C are perspective views showing the outline of a manufacturing process up to a point where the can body W1 according to the first example is obtained.

First, as shown in FIG. 2A, as traveled in a direction of arrow T1, a material steel sheet M is irradiated with, for example, pulse laser beams by laser irradiating devices L1 and L3 to form laser-machined portions.

While four laser irradiating devices L1, L2, L3 and L4 are provided in FIG. 2A, in this example, the laser irradiating devices L2 and L4 whose laser beams are illustrated with dashed-line cones are not used and the laser irradiating devices L1 and L3 whose laser beams are illustrated with solid-line cones are used.

The laser irradiating device L1 forms a laser-machined portion G1 on a top surface in the drawing and the laser irradiating device L3 forms a laser-machined portion G3 on a bottom surface in the drawing.

Next, as shown in FIG. 2B, the material steel sheet M is bent so that the laser-machined portion G1 and the laser-machined portion G3 face each other, and edges (corresponding portions) of the shaped material steel sheet M to be joined are overlapped to form a can body intermediate product W2 with welding-expected portions 12, which are to be the welded portion 11, being ready for welding. In this example, the laser-machined portions G are formed up to ends of the material steel sheet M.

As the thus formed can body intermediate product W2 is traveled in a direction of arrow T2, the welding-expected portions 12 are sandwiched by electrode rollers A (A1 and A2) and a current is passed to seam-weld (resistance-weld) the welding-expected portions 12 to thereby form the welded portion 11. Thus, the welding-expected portions 12 are joined.

As a result of processes shown in FIGS. 2A and 2B, the can body W1 shown in FIG. 2C is manufactured.

Thereafter, the top plate W11 and the bottom plate W12 are seamed to the can body W1. The prismatic can W0 is thus manufactured.

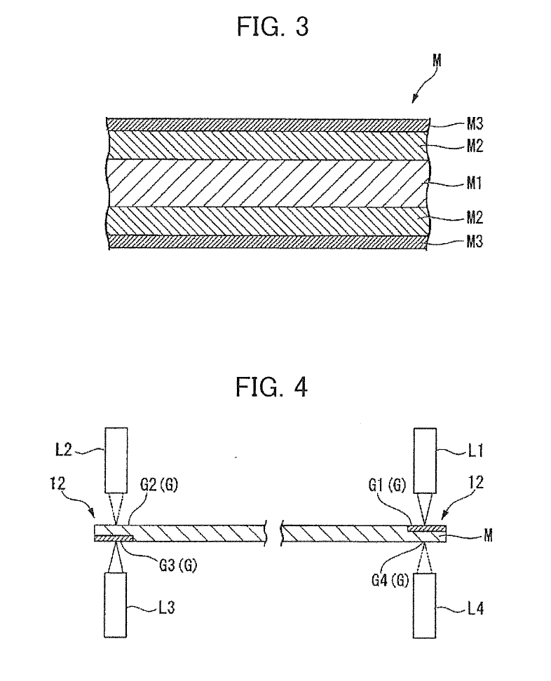

Next, a general configuration of the material steel sheet M to be used for the can W according to the first example is described with reference to FIG. 3. FIG. 3 is a cross-sectional view showing the general configuration of the material steel sheet M according to the first example. In this example, the material steel sheet M is a tin free steel sheet which is commonly used as a material of cans.

The tin free steel sheet constituting the material steel sheet M is composed of a steel sheet M1, chromium plating layers M2 applied on both surfaces of the steel sheet M1, and hydrated chromium oxide layers M3 formed on both outer surfaces of the chromium plating layers M2.

Due to this configuration, the tin free steel sheet has a high electrical resistance because of the chromium plating film and, therefore, physical polishing is performed as a pretreatment of resistance welding. However, when normal physical polishing is carried out, polishing powder or debris may adhere.

Next, the outline of a laser irradiation step in the manufacturing process of the can W according to the first example is described with reference to FIG. 4. FIG. 4 is a view showing the outline of the laser irradiation step in the manufacturing process of the can W according to the first example.

In the laser irradiation step, for instance, the four laser irradiating devices L1, L2, L3 and L4 are used as shown in FIG. 2A mentioned above and FIG. 4. Each pair of the laser irradiating devices L1 and L4 and the laser irradiating devices L2 and L3 are arranged to face each other.

The laser irradiating devices L1, L2, L3 and L4 irradiate the welding-expected portions 12 located at the edges of the material steel sheet M and are to be the welded portion 11 with, for example, pulse laser beams to thereby remove the chromium plating on the material steel sheet M.

The chromium plating on the material steel sheet M is removed to form the laser-machined portions G in which laser-irradiated portions at which the steel sheet M1 is exposed are distributed.

It should be noted that FIG. 4 is a view conceptually showing the positions of the laser-machined portions G and for ease of understanding, the laser-machined portions G are emphasized in the thickness direction.

As described above, in this example, the laser irradiating devices L2 and L4 whose laser beams are illustrated with dashed-line cones are not used and the laser irradiating devices L1 and L3 whose laser beams are illustrated with solid-line cones are used.

Since the laser irradiating devices L1 and L3 are used, the laser-irradiated portions G1 and G3 are formed at the edges which are positioned at the opposite surfaces of the material steel sheet M and correspond to each other when overlapped.

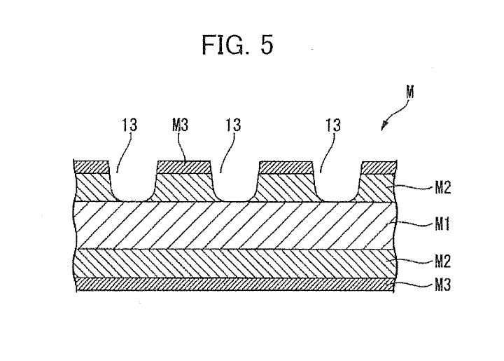

Next, a general configuration of the laser-irradiated portions formed at the material steel sheet M according to the first example is described with reference to FIG. 5. FIG. 5 is a cross-sectional view showing the general configuration of the laser-irradiated portions formed at the material steel sheet M according to the first example. In FIG. 5, the laser-irradiated portions are formed solely on one side.

As shown in FIG. 5, the laser-irradiated portions 13 are formed to penetrate from the surface of the material steel sheet M, through the chromium plating layer M2 and the hydrated chromium oxide layer M3, to the steel sheet M1.

The amount of deposited chromium at the laser-irradiated portions 13 is preferably up to 5 mg/m², for example.

The laser-irradiated portions 13 have an area of preferably 10% or more but not more than 90%, and more preferably 20% or more but not more than 50% of a region of the welded portion.

To measure the area of the laser-irradiated portions 13 in the region of the welded portion 11 (welding-expected portion 12), one effective method is, for instance, obtaining an area ratio of the laser-irradiated portions 13 in a 1 mm×1 mm area in the laser-machined portion G.

As described above, the steel sheet M1 is exposed at part of the material steel sheet M and the hydrated chromium oxide layer M3 remains at the other part. Consequently, the electrical resistance is lowered at the laser-irradiated portions 13 where the steel sheet M1 is exposed, which allows a current to easily pass, thereby improving weldability.

As a result, adhesion to a paint film applied in repair painting or the like and the corrosion resistance thereof are ensured well at the part where the hydrated chromium oxide layer M3 is formed, thus improving the adhesion to a resin film such as a repair paint film or a repair laminating film at the welded portion.

Furthermore, compared to peeling over the entire region with a laser, the amount of required laser energy is greatly reduced and this enables high-speed formation of the laser-machined portion. Therefore, this method can compete with a normal can manufacturing method on speed and can be easily put to practical use.

Furthermore, since the arrangement of the laser-irradiated portions 13 is controlled, unlike when the chromium plating film remains in physical polishing, the electrical resistance at the welded portion is uniformly lowered so that stable weldability can be ensured.

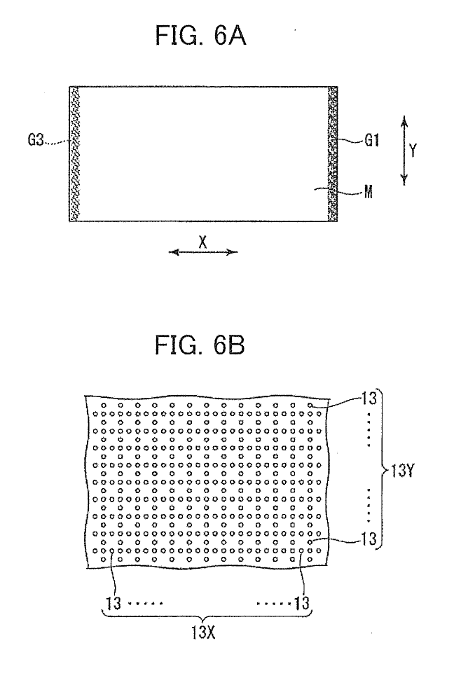

Next, the arrangement of the laser-machined portions G at the material steel sheet to be used for the can body W1 according to the first example is described with reference to FIGS. 6A and 6B.

FIG. 6A is a schematic view showing an exemplary arrangement of the laser-machined portions G (G1, G3) at the material steel sheet M to be used for the can body W1 according to the first example, and FIG. 6B is a view showing an exemplary general configuration of the laser-irradiated portions 13 in the laser-machined portion G.

The laser-machined portions G are arranged at the material steel sheet M so that, for instance, the laser-machined portion G1 is formed on one surface of the material steel sheet M while the laser-machined portion G3 is formed on the other surface of the material steel sheet M as shown in FIG. 6A.

The laser-machined portions G1 and G3 are positioned to make up the welded portion 11 and constitute the welding-expected portions 12.

The arrangement of the laser-irradiated portions 13 in the laser-machined portion G is configured to have collections 13X each including a plurality of laser-irradiated portions 13 formed along a width direction of the laser-machined portion G and collections 13Y each including a plurality of laser-irradiated portions 13 formed along a longitudinal direction perpendicular to the collections 13X of the laser-irradiated portions 13, as shown in FIG. 6B.

With this configuration, the laser-irradiated portions 13 can be uniformly arranged in a predetermined region of the welded portion 11 in the laser-machined portions G. The other parts than the irradiated portions 13 can also be uniformly arranged.

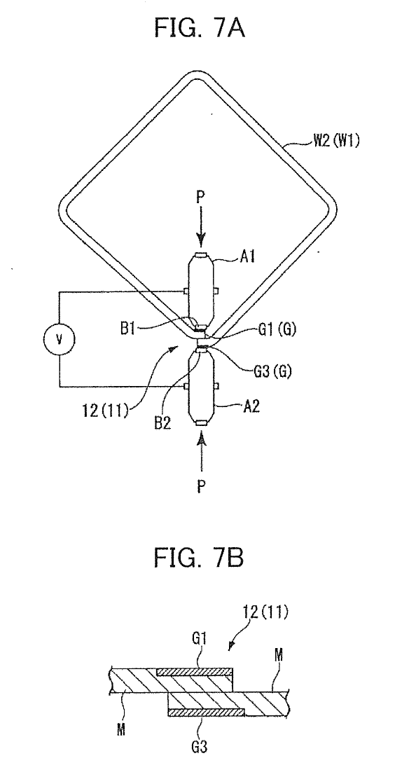

Next, the outline of resistance welding of the welding-expected portions 12 in the weld can manufacturing process according to the first example is described with reference to FIGS. 7A and 7B.

FIG. 7A is a view showing resistance welding of the welding-expected portions 12 in the weld can manufacturing process according to the first example, specifically showing the outline of the state where the welding-expected portions 12 of the can body intermediate product W2 are seam-welded by the electrode rollers A1 and A2.

FIG. 7B is a view showing an exemplary arrangement of the laser-machined portions G at the welding-expected portions 12 in the weld can manufacturing process according to the first example.

In resistance welding of the welding-expected portions 12 of the can body intermediate product W2, as the shaped can body intermediate product W2 is moved in a longitudinal direction of the welding-expected portions 12, the welding-expected portions are sandwiched by the electrode rollers A1 and A2 so that a current passes therethrough, whereby the portions in question are welded and the welded portion 11 is formed, for example.

When the welding-expected portions 12 are seam-welded, the laser-machined portions G at the welding-expected portions 12 in this example are arranged so that, for instance, the laser-machined portion G1 is positioned on a surface to be brought in contact with the electrode roller A1 while the laser-machined portion G3 is positioned on a surface to be brought in contact with the electrode roller A2.

No laser-machined portions G are formed and chromium platings remain at interface sides at which the edges of the material steel sheet M are in contact with each other.

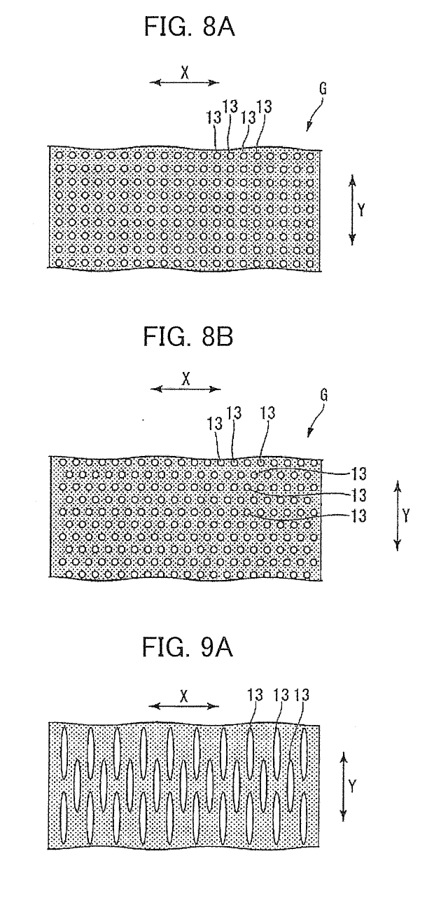

Next, modifications of the configuration of the laser-irradiated portions 13 in the laser-machined portion G of the material steel sheet to be used for the can body W1 according to the first example are described with reference to FIGS. 8A and 8B. FIGS. 8A and 8B are views illustrating general configurations of arrangement modifications of the laser-irradiated portions 13 in the laser-machined portion G of the material steel sheet M to be used for the can body W1 according to the first example. In FIGS. 8A and 8B, for example, the longitudinal direction of the laser-machined portion G is denoted by Y.

FIG. 8A is a view showing a first modification of the first example. For example, the laser-irradiated portions 13 are arranged at equal intervals in the width direction (X direction) of the laser-machined portion G, and groups of the laser-irradiated portions 13 arranged at equal intervals in the X direction are arranged in a repetitive manner in the longitudinal direction (Y direction) of the laser-machined portion G. An interval of adjacent laser-irradiated portions 13 in the X direction or the Y direction is substantially the same as the size of each laser-irradiated portion 13.

FIG. 8B is a view showing a second modification of the first example. For example, the laser-irradiated portions 13 are arranged at equal intervals in the width direction (X direction) of the laser-machined portion G, and groups of the laser-irradiated portions 13 arranged at equal intervals in the X direction are arranged in a repetitive manner in the longitudinal direction (Y direction) of the laser-machined portion G with their positions in the X direction being offset by a half pitch. An interval of adjacent laser-irradiated portions 13 in the X direction or the Y direction is substantially the same as the size of each laser-irradiated portion 13.

In the can body W1 and the prismatic can W0 according to the first example, the laser-machined portions G1 and G3 are formed at, of the welding-expected portions 12 of the material steel sheet M, two regions constituting electrode contact regions so that the contact resistance can be decreased. Therefore, the welding-expected portions 12 can be effectively seam-welded.

In addition, the laser-irradiated portions 13 are dividedly arranged in the welding-expected portions 12 and consequently, the laser-machined portions G can be formed at a high speed.

According to the can body W1 and the prismatic can W0 of the first example, the amount of deposited chromium at the laser-irradiated portions 13 is up to 5 mg/m² in terms of chromium metal and therefore, the welding-expected portions 12 can be stably seam-welded.

According to the can body W1 and the prismatic can W0 of the first example, the laser-irradiated portions 13 have an area of, for instance, 10% or more but not more than 90% of a given 1 mm×1 mm area in the welded portion 11.

Since the area of the laser-irradiated portions is defined to be 10% or more but not more than 90% of a given 1 mm×1 mm area in the welded portion 11, this improves, as well as weldability, adhesion to a resin film such as a repair paint film or a repair laminating film when the welded portion 11 undergoes repair painting or repair laminating and, accordingly, enhances corrosion resistance.

When the area ratio is 20 to 50%, this leads to a large ACR and also enables to make the area in which chromium is removed sufficiently small compared to removal over the entire region (removing chromium over the entire region of the laser-machined portions).

As a result, the laser output per unit area of the laser-machined portions G can be decreased and even when the laser output per unit time is the same, the laser-machined portions G can be formed at a higher speed. This makes our welded can bodies, welded cans and methods further advantageous.

According to the can body W1 and the prismatic can W0 of the first example, the laser-machined portions G are constituted by two electrode contact regions and therefore, the cost can be reduced compared to when laser-machined portions are formed at all regions (four regions) constituting the welded portion 11.

Furthermore, compared to when the laser-machined portions G are formed at two joint regions at which the edges of the material steel sheet M are joined, a large ACR can be ensured in seam welding, thereby improving the weldability.

In general, when the contact resistance between surfaces of a material is set higher than the contact resistance at a surface brought in contact with an electrode, the interface between the surfaces of the steel sheet is sufficiently melted and this leads to the reduction in weld splash or flying dust. Therefore, a large and excellent ACR can be ensured. The term “weld splash” used here refers to needle-like fragments of the material steel sheet M protruding from a welded portion and adhering to the resultant weld can or weld can body.

To be more specific, in resistance welding, heat is generated at a portion having a high resistance and a contact portion between the electrode and the material steel sheet is generally cooled down by the electrode but the electrode itself has a low resistance and, therefore, a joint portion between edges of the material steel sheet M (steel sheet-steel sheet interface) has a higher electric resistance than that of the contact portion between the electrode and the material steel sheet (electrode-steel sheet interface) so that a large amount of heat is generated at the joint portion and the joint portion is melted, whereby stable welding is performed.

However, when the laser-machined portion is formed at the joint portion between the edges of the material steel sheet M, on the one hand, the electric resistance is lowered as a whole and weldability is improved but, on the other hand, the amount of heat generated at the contact portion between the electrode and the material steel sheet M sometimes becomes larger than that at the joint portion and the material steel sheet M is easily melted on the side close to the electrode.

Therefore, it appears to be effective to form the laser-machined portion at each contact portion between an either electrode and the material steel sheet M and thereby lower the electric resistance at each contact portion between an either electrode and the material steel sheet M to enlarge the ACR.

### Second Example

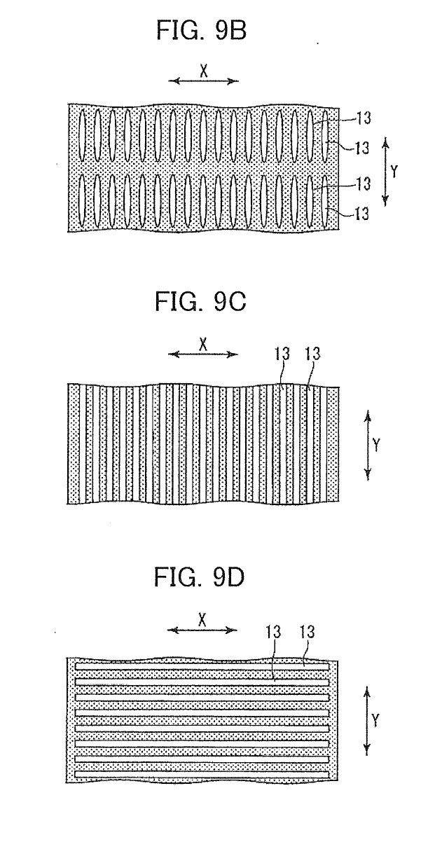

A second example is described below with reference to FIGS. 9A to 9D.

FIG. 9A is a schematic view showing laser-irradiated portions in the laser-machined portion G of the material steel sheet to be used for a weld can body according to the second example, and FIGS. 9B to 9D are schematic views illustrating modifications of the second example. In FIGS. 9A to 9D, for example, the longitudinal direction of the laser-machined portion G is denoted by Y and the width direction thereof by X.

The laser machined portion G according to the second example is configured so that, for example, as shown in FIG. 9A, a plurality of laser-irradiated portions 13 having a predetermined length in the Y direction are arranged in the X direction, and a plurality of laser-irradiated portions 13 respectively adjacent in the X direction to the foregoing laser-irradiated portions 13 are arranged with their positions in the Y direction being offset from their adjacent laser-irradiated portions 13 by a half pitch.

Either of pulse laser and continuous laser may be used to form the laser-machined portion G, and the length of the laser-irradiated portion 13 can be arbitrarily set as required.

The laser-machined portion G according to a first modification of the second example is configured so that, for example, as shown in FIG. 9B, a plurality of laser-irradiated portions 13 having a predetermined length in the Y direction are arranged in the X direction, and a plurality of groups each including the laser-irradiated portions 13 having such an arrangement are arranged in the Y direction.

The laser-machined portion G according to a second modification of the second example is configured so that, for example, as shown in FIG. 9C, a plurality of laser-irradiated portions 13 formed to extend between the opposite ends of the laser-machined portion G in the longitudinal direction are arranged in the X direction at predetermined intervals.

The laser-machined portion G according to a third modification of the second example is configured so that, for example, as shown in FIG. 9D, a plurality of laser-irradiated portions 13 formed to extend between the opposite ends of the laser-machined portion G in the X direction are arranged in the Y direction at predetermined intervals.

### Third Example

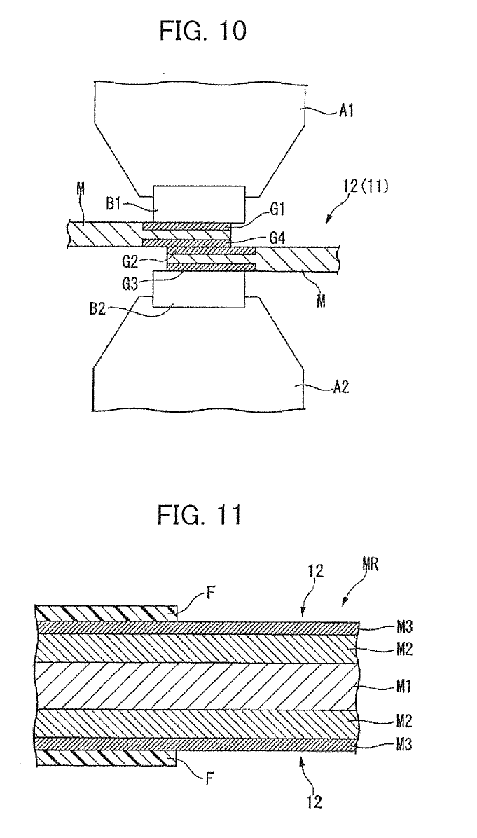

A third example is described below with reference to FIG. 10.

FIG. 10 is a view illustrating a general configuration of arrangement of laser-machined portions G at the material steel sheet M when the welding-expected portions 12 are seam-welded in a weld can body manufacturing process according to the third example.

The third example is different from the first example in that, while the laser-machined portions G1 and G3 are formed at two regions constituting the electrode contact regions in the first example, the laser-machined portions G1 and G3 are formed at two regions constituting the electrode contact regions in the third example.

In addition, in the third example, laser-machined portions G2 and G4 are formed also at two regions constituting joint regions at the interface at which the edges of the material steel sheet M are joined and thus, the laser-machined portions G are formed at all of the four regions constituting the welded portion 11. The remaining configuration is the same as in the first example and therefore the explanation thereof will not be made.

### Fourth Example

A fourth example is described below with reference to FIG. 11.

FIG. 11 is a cross-sectional view showing a general configuration of a material steel sheet constituted by a laminated steel sheet (resin-coated steel sheet) MR according to the fourth example.

The fourth example is different from the first example in that the laminated steel sheet MR is used for the material steel sheet constituting a can body W1. The remaining configuration is the same as in the first example and, therefore, the explanation thereof will not be made.

The laminated steel sheet MR includes the steel sheet M1, the chromium plating layers M2 applied on both surfaces of the steel sheet M1, the hydrated chromium oxide layers M3 formed on both outer surfaces of the chromium plating layers M2, and laminating films F formed on both outer surfaces of the hydrated chromium oxide layers M3, as shown in FIG. 11. In this example, the laminating films F do not cover the welding-expected portions 12. While FIG. 11 illustrates no details on the laminating films F, various types of laminating films according to filling contents are applicable, and a laminating film made up of plural layers having different functions is also applicable.

### Fifth Example

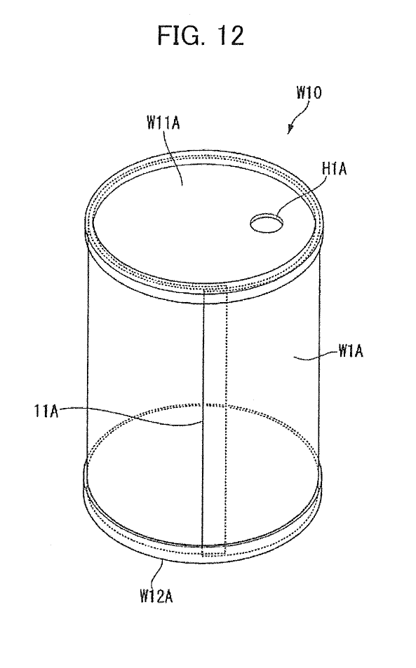

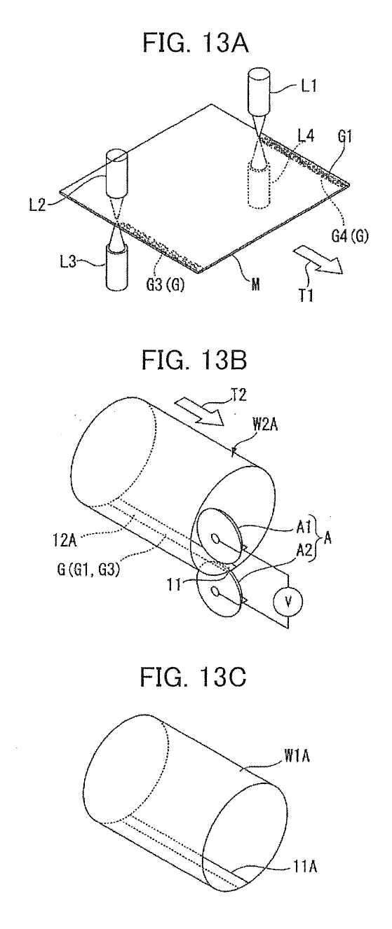

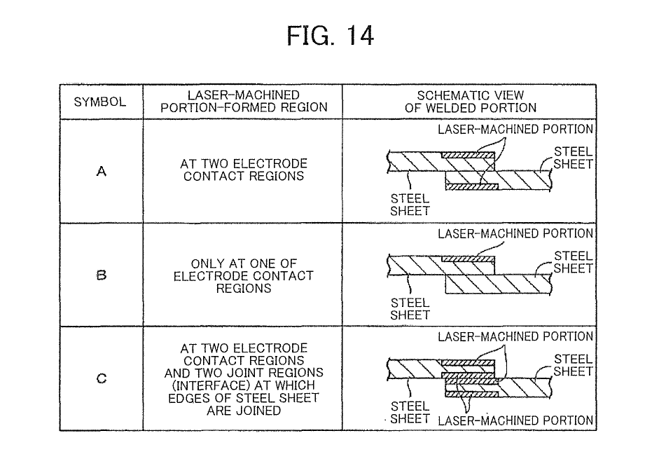

A fifth example is described below with reference to FIGS. 12 and 13A to 13C.

FIG. 12 is a view showing a general configuration of a can according to the fifth example. Reference symbol W10 denotes a cylindrical can (weld can) having a cylindrical periphery such as a pail can for instance, reference symbol W1A denotes a can body (weld can body), and reference symbol 11A denotes a welded portion of the can body W1A and the weld can W1A.

The cylindrical can W10 includes, for instance, the can body W1A formed in a cylindrical shape, a top plate W11A, and a bottom plate W12A, and the top plate W11A and the bottom plate W12A are separately attached to openings of the can body W1A at the opposite ends thereof, as shown in FIG. 12.

A hole H1A is formed at the top plate W11A to allow the contents to enter and fill the interior of the cylindrical can W10 or to drain to the outside.

Joining of the can body W1A is carried out by, for instance, curving the material steel sheet having been shaped, overlapping edges of corresponding sides of the material steel sheet and resistance-welding the overlapped portions to thereby form the welded portion 11A.

Next, the outline of a manufacturing method of a can W according to the fifth example is described with reference to FIGS. 13A to 13C. FIGS. 13A to 13C are perspective views showing the outline of a manufacturing process up to the point where the can body W1A according to the fifth example is obtained.

First, as shown in FIG. 13A, as traveled in a direction of arrow T1, the material steel sheet M is irradiated with, for example, pulse laser beams by the laser irradiating devices L1 and L3 to form laser-machined portions.

While the four laser irradiating devices L1, L2, L3 and L4 are provided in FIG. 13A, in this example, the laser irradiating devices L2 and L4 whose laser beams are illustrated with dashed-line cones are not used and the laser irradiating devices L1 and L3 whose laser beams are illustrated with solid-line cones are used.

The laser irradiating device L1 forms the laser-machined portion G1 on the top surface in the drawing and the laser irradiating device L3 forms the laser-machined portion G3 on the bottom surface in the drawing.

Next, as shown in FIG. 13B, the material steel sheet M is curved so that the laser-machined portion G1 and the laser-machined portion G3 face each other, and edges (corresponding portions) of the shaped material steel sheet M to be joined are overlapped to form a can body intermediate product W2A with welding-expected portions 12A, which are to be the welded portion 11, being ready for welding. In this example, the laser-machined portions G are formed up to ends of the material steel sheet M.

As the thus formed can body intermediate product W2A is traveled in a direction of arrow T2, the welding-expected portions 12A are sandwiched by the electrode rollers A (A1 and A2) and a current is passed to seam-weld (resistance-weld) the welding-expected portions 12A to thereby form the welded portion 11A. Thus, the welding-expected portions 12A are joined.

As a result of processes shown in FIG. 13A and FIG. 13B, the can body W1A shown in FIG. 13C is manufactured.

Thereafter, the top plate W11A and the bottom plate W12A are seamed to the can body W1A. The cylindrical can W10 is thus manufactured.

It should be noted that our welded can bodies, welded cans and methods are by no means limited to the foregoing examples and various improvements and modifications are possible without departing from the scope and spirit of this disclosure.

For example, while in the foregoing examples, the prismatic can W0 and the cylindrical can W10 as well as the can bodies W1 and W1A corresponding thereto are described, these examples can be applied to weld cans having other shapes or weld can bodies used for such weld cans such as 5-gallon cans, jerrycans and three-piece cans including one employed for use as a beverage container.

While in the foregoing examples, the explanation is made on the case of laser machining performed by irradiating a tin free steel sheet with pulse laser, the laser-machined portion G may be formed by continuous irradiation with laser.

While in the foregoing examples, the explanation is made when the amount of deposited chromium at the laser-irradiated portions is up to 5 mg/m², the amount of deposited chromium may be arbitrarily set within the range in which resistance welding of the welding-expected portions is possible, and a smaller amount of deposited chromium is effective at improving weldability.

While in the foregoing examples, the explanation is made on the case where the laser-irradiated portions have an area ratio of, for instance, 10% or more but not more than 90% in a 1 mm×1 mm area in the welded portion, the area ratio of the laser-irradiated portions 13 in the welded portion 11 may be arbitrarily set within the range in which resistance welding of the welding-expected portions 12 is possible. For instance, a higher area ratio of the laser-irradiated portions 13 in the welding-expected portions 12 is effective at improving the weldability. Furthermore, a lower density of the laser-irradiated portions is effective at improving the adhesion at the welded portion when the welded portion undergoes repair painting or repair laminating and thereby improving the corrosion resistance.

While in the foregoing examples, the explanation is made when the material steel sheet is the tin free steel sheet or the laminated steel sheet, the material steel sheet may be configured to have a steel sheet that is the base material applied on its one surface with chromium plating and on its other surface with chromium plating and then with a laminating film. In addition, the lamination layer may be made up of plural layers as described above.

### Numerical Examples

Numerical Examples are described below with reference to Table 1.

Table 1 shows results of evaluation conducted with Examples 1 to 13 and Comparative Examples 1 and 2 in terms of high-speed weldability, paint adhesion, corrosion resistance and weldability.

Examples 1 to 13 and Comparative Examples 1 and 2 were each prepared with the use of a tin free steel sheet obtained by applying chromium plating on a cold rolled steel sheet having a thickness of 0.32 mm and T4CA temper. The area ratio (%) of the laser-irradiated portions in the welded portion, the arrangement of the laser-machined portions (A, B, C) at the welded portion, and the amount of deposited chromium (mg/m²) at the laser-irradiated portions in each of Examples 1 to 13 and Comparative Examples 1 and 2 are as shown in Table 1.

High-speed weldability, paint adhesion, corrosion resistance and weldability were evaluated by methods described below.

The arrangements of the laser-machined portions (A, B, C) at the welded portion shown in Table 1 are described in FIG. 14. FIG. 14 shows each arrangement (presence or absence) of the laser-machined portions at four regions constituting the welded portion.

### Evaluation of High-Speed Weldability

In a weldability test, when a region in question was entirely irradiated with laser and the amount of deposited Cr at the laser-irradiated portions was up to 1 mg/m² was defined as 100% laser output, and the comparison was made. When the laser output required to form the laser-machined portion having the same area as the area of the region in question was more than 90%, the evaluation result was determined as Impossible (x); when the laser output was more than 50% but not more than 90%, determined as Possible (∘); and when the laser output was not more than 50%, determined as Excellent (⊚).

### Evaluation of Paint Adhesion

A surface on which the laser-machined portion had been formed was applied with epoxy paint, followed by baking at 220° C. for 10 minutes, thereby forming a coating with a thickness of 5 μm. Subsequently, marking-off lines were formed in a grid pattern on the painted surface of each painted sample so that the lines were arranged at vertical and horizontal intervals of 2 mm. The marking-off lines had enough depth to reach the steel layer.

Subsequently, a Cellotape (registered trademark) (LP24) manufactured by Nichiban Co., Ltd. was applied on the marking-off line-formed portion at the painted surface. At this time, the tape was, as being pulled out from a coil-like roll of the tape, applied on the sample. Nonadhesive portions were provided to the tape as tape edges to be continuous with the tape-applied portion. The tape-applied portion was sufficiently pressed from above so that the tape was tightly adhered to the sample.

The thus prepared sample was fixed and the tape edges were pinched and swiftly pulled at an angle of 45° with respect to the plane of the sample, thereby peeling the tape off. When the paint came off at the time the tape peeled off, this was determined as Poor (x); and when the paint did not come off, determined as Good (∘).

### Evaluation of Corrosion Resistance

Both surfaces of each sample on which the laser-machined portion(s) had been formed were applied with epoxy paint, followed by baking at 220° C. for 10 minutes, thereby forming a coating with a thickness of 5 μm. Subsequently, the painted sample was sheared into a 70 mm×70 mm size, and two marking-off lines were diagonally formed on the surface on which the laser-machined portion had been formed. The marking-off lines had enough depth to reach the steel layer.

Next, a corrosive liquid was prepared. The corrosive liquid was prepared from a mixed aqueous solution of sodium chloride and citric acid so that the sodium chloride content was 1.5 wt % and the citric acid content was 1.5 wt %.

Subsequently, a cylindrical cell having a diameter of 50 mm with a lid was prepared. The lid was attached to the cylindrical cell, and the cylindrical cell was placed with the lid being the bottom and filled with the corrosive liquid prepared. The sample was put as an upper lid on the cell filled with the corrosive liquid so that the marking-off line-formed surface faces the inside of the cell with its center portion being positioned at the center axis of the cell, and the cell and the sample were lashed so that the liquid was not leaked even when they were turned upside down. Thereafter, the cylindrical cell was turned so that the sample comes to the bottom and placed in a thermostat bath at 38° C. for 4 days.

After elapse of the time above, the sample was taken out and the corrosion condition was observed. When the corrosion occurred only at the making-off line-formed portion, this was determined as Good (∘); and when the corrosion was in progress under the paint coating, determined as Poor (x).

### Evaluation of Weldability

With the use of the tin free steel sheet obtained by applying chromium plating on the cold rolled steel sheet having a thickness of 0.32 mm and T4CA temper, the laser-machined portion(s) was formed at welding portions according to each of Examples and Comparative Examples, and then welding was carried out by a seam welding method. Too high welding current results in dust or weld splash and is inappropriate, whereas too low welding current results in weak joining power at welding and is inappropriate. The range in which sufficient joining power is exhibited at welding and neither dust nor weld splash is generated is called “weldable current range (ACR).” The wider the ACR is, the more stable the welding is.

When the weldable current range was less than 1 A, this was determined as Poor (x); when it was not less than 1 A but less than 3 A, determined as Good (∘); and when it was not less than 3 A, determined as Excellent (⊚). The result at or above 1 A was regarded as acceptable.

TABLE 1

| | | Laser- | Amount of | | | | |
|---|---|---|---|---|---|---|---|
| | | machined | deposited | | | | |
| | | portion- | Cr at laser- | | | | |
| | Area | formed | machined | High-speed | Paint | Corrosion | |
| | ratio (%) | region | portion (mg/m²) | weldability | adhesion | resistance | Weldability |
| Example 1 | 10 | A | <1 | ⊚ | ◯ | ◯ | ◯ |
| Example 2 | 20 | A | <1 | ⊚ | ◯ | ◯ | ⊚ |
| Example 3 | 30 | A | <1 | ⊚ | ◯ | ◯ | ⊚ |
| Example 4 | 40 | A | <1 | ⊚ | ◯ | ◯ | ⊚ |
| Example 5 | 50 | A | <1 | ⊚ | ◯ | ◯ | ⊚ |
| Example 6 | 70 | A | <1 | ◯ | ◯ | ◯ | ⊚ |
| Example 7 | 90 | A | <1 | ◯ | ◯ | ◯ | ⊚ |
| Example 8 | 30 | A | 3 | ⊚ | ◯ | ◯ | ◯ |
| Example 9 | 30 | A | 5 | ⊚ | ◯ | ◯ | ◯ |
| Example 10 | 30 | B | <1 | ⊚ | ◯ | ◯ | ◯ |
| Example 11 | 40 | B | <1 | ⊚ | ◯ | ◯ | ◯ |
| Example 12 | 50 | B | <1 | ◯ | ◯ | ◯ | ◯ |
| Example 13 | 30 | C | <1 | ⊚ | ◯ | ◯ | ◯ |
| Comparative | 100 | A | <1 | X | X | X | ⊚ |
| Example 1 | | | | | | | |
| Comparative | 0 | — | — | ⊚ | ◯ | ◯ | X |
| Example 2 | | | | | | | |

### Evaluation Results

(1) Examples 1 to 13 exhibited good results in all of high-speed weldability, paint adhesion, corrosion resistance and weldability.
(2) In particular, Examples 2 to 7 exhibited excellent results (⊚) in weldability.
(3) While Examples 8 and 9 had the same conditions as those of Example 2 except that the amounts of deposited Cr at the laser-machined portions were 3 mg/m² and 5 mg/m², respectively, weldability in both cases was Good (∘) due to a large amount of deposited and remaining Cr.
(4) Examples 10 to 12 had the same conditions as those of Examples 3 to 5 except that the laser-machined portion-formed region is B (in which the laser-machined portion was formed at only one of two electrode contact regions), and since the laser-machined portion was formed on only one side, weldability in both cases was Good (∘).
(5) In Comparative Example 1, the area ratio of the laser-irradiated portions in the laser-machined portions was 100% and the laser-irradiated portions were formed at, out of regions constituting the welded portion, two regions to be brought into contact with the electrodes. As a result, Comparative Example 1 was inferior in high-speed weldability, paint adhesion and corrosion resistance.
(6) In Comparative Example 2, since the area ratio of the laser-irradiated portion in the laser-machined portion was 0% and this means that the laser non-irradiated portion extends over the entire welded portion and no laser-irradiated portion was formed, Comparative Example 2 is out of the scope of claims of the present application. As a result, weldability was Poor (x).

As described above, compared to the conventional laser polishing method (see JP '682) in which the entire region of a welding portion is irradiated with laser (polishing area ratio 100% (at which there is no part where polishing was not performed)), provision of laser-irradiated portions and non-irradiated portions leads to improvement in high-speed weldability, paint adhesion and corrosion resistance.

Compared to peeling over the entire region with laser, the amount of required laser energy per unit area is reduced, and when the amount of laser energy (output) per unit time is constant, the laser-machined portion can be formed at a high speed.

Even at the laser-irradiated portions (polished portions), the amount of remaining chromium is up to 5 mg/m² in terms of chromium metal and therefore, stable weldability is ensured.

### INDUSTRIAL APPLICABILITY

Weldability of a material steel sheet at resistance welding can be improved and therefore, this is industrially applicable.

1-10. (canceled)

11. A weld can body obtainable by shaping a material steel sheet comprising a tin free steel sheet or a resin-coated steel sheet having a tin free steel sheet covered with a resin film, overlapping corresponding portions with each other, and performing resistance welding on the corresponding portions overlapped to thereby form a welded portion,
wherein, on welding-expected portions to be the welded portion in the material steel sheet, at least one of four regions consisting of two regions constituting electrode contact regions to be brought in contact with electrodes at the resistance welding and two regions constituting joint regions at which the corresponding portions of the material steel sheet are joined by the resistance welding is subjected to laser irradiation before the resistance welding to form a laser-machined portion, wherein laser-irradiated portions at which chromium plating is removed and a steel sheet is exposed are dividedly arranged.

12. The weld can body according to claim 11, wherein an amount of deposited chromium at the laser-irradiated portions is up to 5 mg/m² in terms of chromium metal.

13. The weld can body according to claim 11, wherein an area of the laser-irradiated portions in the laser-machined portion is 10% or more but not more than 90% of the laser-machined portion.

14. The weld can body according to claim 11, wherein the laser-machined portions are formed at, of the four regions constituting the welded portion, the two electrode contact regions.

15. A weld can producible by attaching either or both of a top plate and a bottom plate to openings of the weld can body according to claim 11.

16. A method of manufacturing a weld can body comprising:
shaping a material steel sheet comprising a chromium-plated steel sheet or a resin-coated steel sheet having a chromium-plated steel sheet covered with a resin film;
on the material steel sheet shaped, forming a laser-machined portion where laser-irradiated portions at which chromium plating is removed and a steel sheet is exposed are dividedly arranged at at least one of four regions consisting of two regions constituting electrode contact regions to be brought in contact with electrodes at resistance welding and two regions constituting joint regions at which corresponding portions of the material steel sheet are joined by the resistance welding, by subjecting to laser irradiation welding-expected portions to be a welded portion of the weld can body;
overlapping the welding-expected portions of the material steel sheet shaped with each other; and
joining by the resistance welding the welding-expected portions overlapped to thereby form the welded portion.

17. The method according to claim 16, wherein an amount of deposited chromium at the laser-irradiated portions is up to 5 mg/m² in terms of chromium metal.

18. The method according to claim 16, wherein an area of the laser-irradiated portions in the laser-machined portion at the welded portion is 10% or more but not more than 90% of the laser-machined portion.

19. The method according to claim 16, wherein the laser-machined portions are formed at, of the four regions constituting the welded portion, the two electrode contact regions.

20. A method of manufacturing a weld can comprising producing the weld can by attaching either or both of a top plate and a bottom plate to openings of the weld can body manufactured by the method according to claim 16.

21. The weld can body according to claim 12, wherein an area of the laser-irradiated portions in the laser-machined portion is 10% or more but not more than 90% of the laser-machined portion.

22. The weld can body according to claim 12, wherein the laser-machined portions are formed at, of the four regions constituting the welded portion, the two electrode contact regions.

23. The weld can body according to claim 13, wherein the laser-machined portions are formed at, of the four regions constituting the welded portion, the two electrode contact regions.

24. The method according to claim 17, wherein an area of the laser-irradiated portions in the laser-machined portion at the welded portion is 10% or more but not more than 90% of the laser-machined portion.

25. The method according to claim 17, wherein the laser-machined portions are formed at, of the four regions constituting the welded portion, the two electrode contact regions.

26. The method according to claim 18, wherein the laser-machined portions are formed at, of the four regions constituting the welded portion, the two electrode contact regions.

27. A weld can producible by attaching either or both of a top plate and a bottom plate to openings of the weld can body according to claim 12.

28. A weld can producible by attaching either or both of a top plate and a bottom plate to openings of the weld can body according to claim 13.

29. A method of manufacturing a weld can comprising producing the weld can by attaching either or both of a top plate and a bottom plate to openings of the weld can body manufactured by the method according to claim 18.
